(19) United States
(12) Patent Application Publication
(10) Pub. No.: US 2009/0133060 A1
(43) Pub. Date: May 21, 2009

(54) Still-Frame Content Navigation

(75) Inventors: Peter T. Barrett, San Francisco, CA (US); David H. Sloo, Menlo Park, CA (US); Ronald A. Morris, San Francisco, CA (US); Gionata Mettifogo, Menlo Park, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/943,698

(22) Filed: Nov. 21, 2007

(51) Int. Cl. H04N 5/445

(52) U.S. Cl. 725/37

(57) ABSTRACT

Still-frame content navigation techniques are described. In an implementation, content is received via a real-time broadcast. A still frame is identified for each of a plurality of segments of the content that is representative of a respective segment. A plurality of the still frames is output in a user interface. Each of the still frames is selectable to navigate to a respective one of the segments that includes the still frame.

### BACKGROUND

The types of content and the methods that are available for delivery of content are ever increasing. For example, content was initially broadcast to devices of users that were configured to receive and output the content, such as through use of a radio to access a broadcast of radio content. Later, users were able to access an “over the air” broadcast of television content, such as through the use of “rabbit ears” (i.e., an antenna), which then expanded to use a variety of other broadcast techniques, such as delivery via “cable”, “digital cable”, “satellite”, and so on.

Users were also provided with access to non-broadcast content. For example, a user may purchase a digital video disk to watch a movie. Because the entirety of the content was available to a user at the time of purchase, techniques were developed to aid the user in navigating through the content, such as to navigate to different scenes. However, these techniques were generally limited to non-broadcast content and were not made available to broadcast content, such as due to a desire to preserve traditional techniques that were used to derive revenue from the content, e.g., through the use of advertisements that were embedded by a content provider in the content.

### SUMMARY

Still-frame content navigation techniques are described. In an implementation, content is received via a real-time broadcast. A still frame is identified for each of a plurality of segments of the content that is representative of a respective segment. A plurality of the still frames is output in a user interface. Each of the still frames is selectable to navigate to a respective one of the segments that includes the still frame.

In another implementation, one or more computer-readable media include instructions that are executable to find a first still frame to identify content in a first segment of content based on characteristics of the first segment of content and find a second still frame to identify content in a second segment of the content based on characteristics of the second segment of the content. The second still frame is taken at a different point in time in relation to the second segment than a point in time from which the first still frame was taken in relation to the first segment. A user interface is output having the first still frame and the second still frame that are selectable to navigate to the first segment of the content and the second segment of the content, respectively.

In a further implementation, a client includes one or more modules to compute a signature for content received via a broadcast stream that identifies the content based on characteristics of the content. The one or more modules further provide an option that is selectable to enable the content to be fast forwarded by locating another stream using the signature. The other stream has a portion of the content that is available for output that is not currently available for output via the broadcast stream.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to employ techniques that provide still-frame content navigation.

FIG. 2 is an illustration of a system showing a network operator and a client of FIG. 1 in greater detail.

FIG. 3 is an illustration of a user interface having a plurality of still frames that are selectable to navigate to respective segments of content received via a broadcast.

FIG. 4 is a flow diagram depicting a procedure in an exemplary implementation in which content, which is received during a real-time broadcast, incorporates still-frame navigation techniques.

FIG. 5 is a flow diagram depicting a procedure in an exemplary implementation in which an option is provided to fast forward content that was originally received via a broadcast stream.

### DETAILED DESCRIPTION

Overview

Users have access to an increasing range of techniques that may be used to consume non-broadcast content, such as video-on-demand, through use of digital video recorders to playback recorded television programs, and so on. Navigation models for broadcast content, however, often lagged these developments for a variety of reasons. For example, non-broadcast content may be reformatted before being provided to users to implement desired navigation techniques, such as to navigate to different scenes in the content through the use of tags in a digital video disc (DVD). Such formatting was not typically available for broadcast content, however. This may be due to a variety of factors, such as to preserve traditional revenue models in which revenue was collected to embed advertisements within the content.

Still-frame content navigation techniques are described. In an implementation, content received from a real-time broadcast is segmented. A still frame is identified, for each of the segments, that is representative of the respective segment. For example, a signature may be formed for the segment based on characteristics of content in the segment, such as through the use of a multidimensional vector in which each dimension represents a different characteristic. A still frame in the segment which most closely corresponds to the signature may then be identified, and thus is “most representative” of the characteristics of the segment as opposed to other frames within the segment.

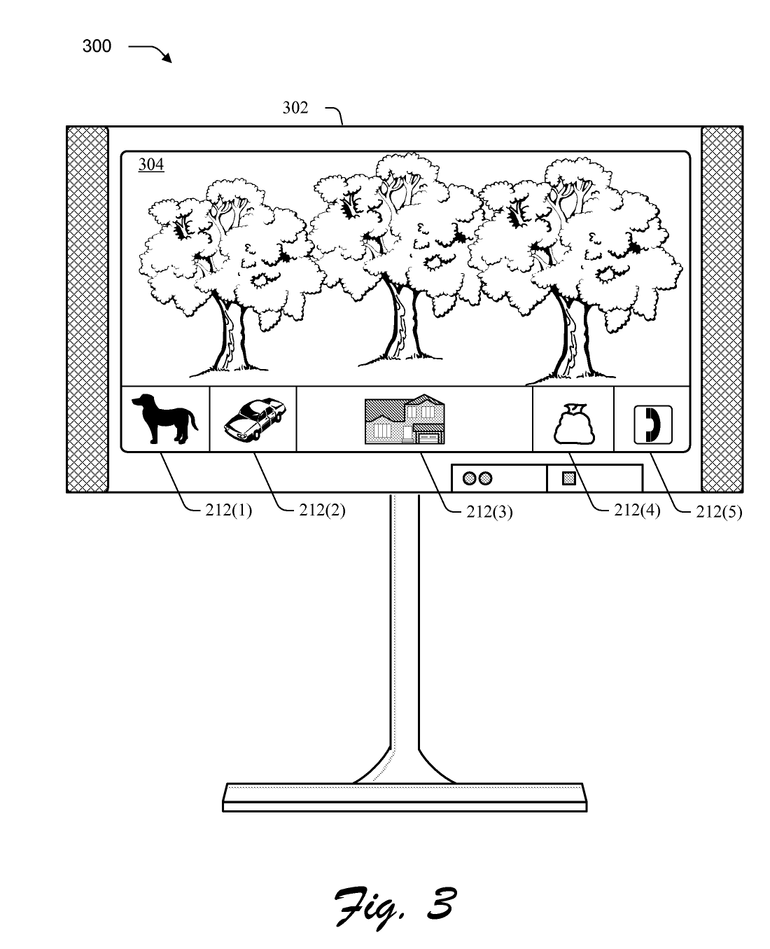

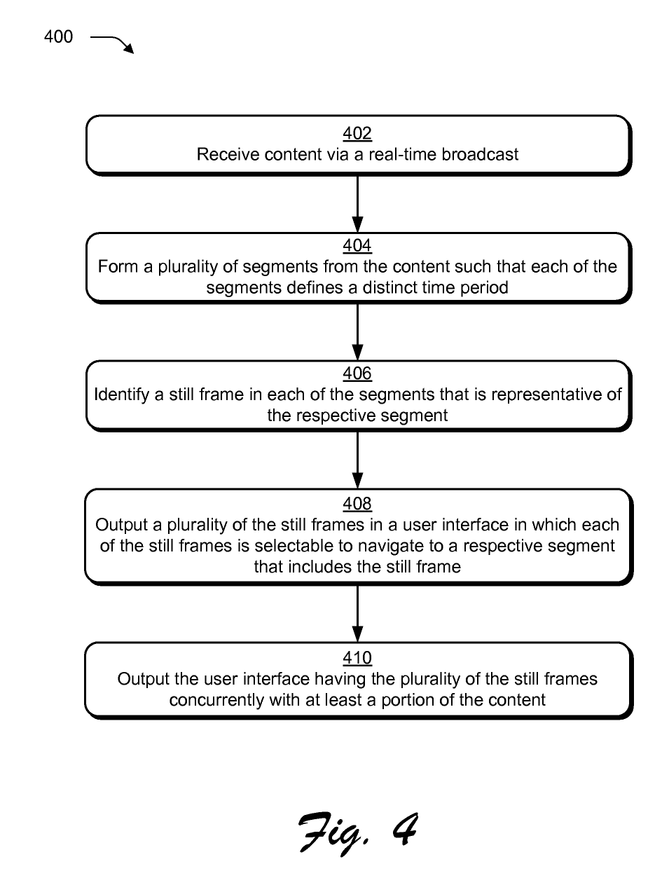

The still frames that are identified for each segment may then be output in a user interface such that selection of the still frame causes navigation to a respective segment, e.g., to a beginning of a segment having the still frame and/or to the still frame itself. Thus, these techniques may be based on the characteristics of the respective segment instead of being taken from regular intervals as was performed using traditional techniques, which sometimes resulted in the use of a “blank” frame. For example, one traditional technique involved taking a frame for similarly-sized segments at a same point in time in the output of the segment, e.g., by taking a still frame for each two minute segment from a beginning of each of the segments. In some instances, the use of this traditional technique would result in the capture of a blank frame, which was not helpful in informing a user as to “what” content was included in the segment. However, the still-frame content navigation techniques presented herein may be used to limit the occurrence of such blank frames, further discussion of which may be found in relation to FIGS. 3 and 4.

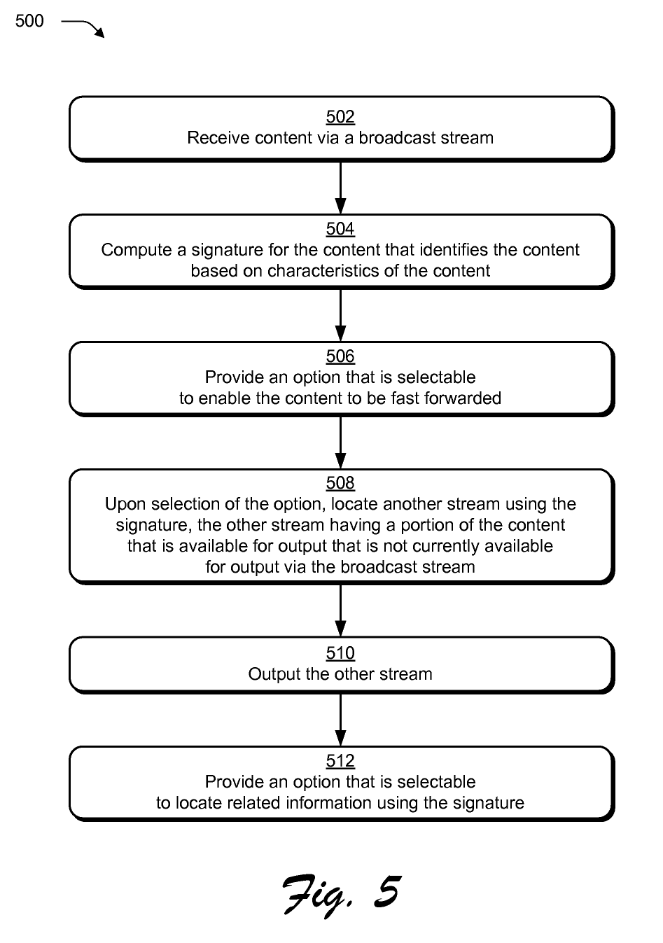

In another implementation, a fast forward option is provided for broadcast content. For example, a user may watch a broadcast of a particular television program (e.g., a movie) that the user has already watched. This movie may have a scene that is a favorite of the user, but is not due to be output for a significant amount of time into the broadcast. Previously, if the user wished to watch that scene, the user waited until that scene was broadcast. However, techniques are described herein in which the content may be identified. An option may then be provided that is selectable to enable the content to be fast forwarded by locating another stream having the movie. This other stream may have the portion (e.g., the scene) that is desired by the user and also is available to output that scene before the output of the content via the broadcast. For example, this other stream may be retrieved from a video-on-demand store. Further discussion of fast forwarding may be found in relation to FIG. 5.

In the following discussion, an exemplary environment is first described that is operable to employ still-frame content navigation techniques. Exemplary procedures are then described that may be employed in the exemplary environment, as well as in other environments. Although these techniques are described as employed within a television environment in the following discussion, it should be readily apparent that these techniques may be incorporated within a variety of environments without departing from the spirit and scope thereof.

Exemplary Environment

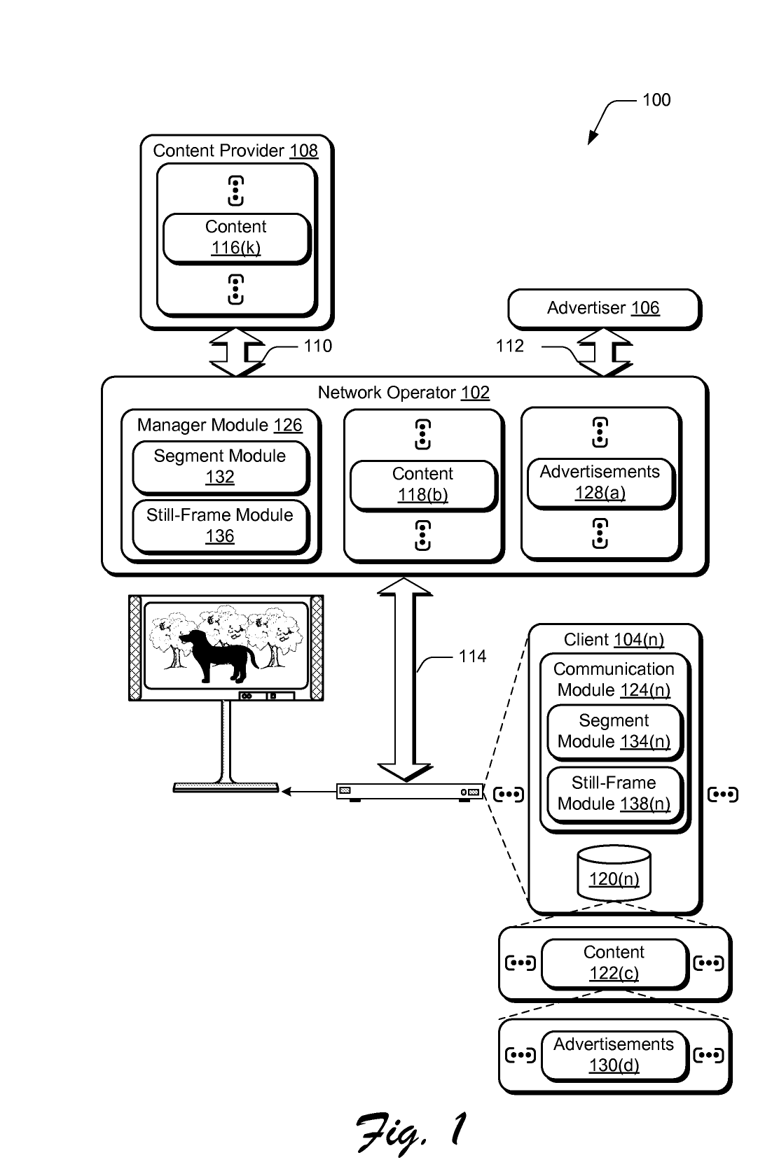

FIG. 1 is an illustration of an environment 100 in an exemplary implementation that is operable to employ still-frame content navigation techniques. The illustrated environment 100 includes a network operator 102 (e.g., a “head end”), one or more clients 104(n), an advertiser 106 and a content provider 108 that are communicatively coupled, one to another, via network connections 110, 112, 114. In the following discussion, the network operator 102, the client 104(n), the advertiser 106 and the content provider 108 may be representative of one or more entities, and therefore reference may be made to a single entity (e.g., the client 104(n)) or multiple entities (e.g., the clients 104(n), the plurality of clients 104(n), and so on). Additionally, although a plurality of network connections 110-114 are shown separately, the network connections 110-114 may be representative of network connections achieved using a single network or multiple networks. For example, network connection 114 may be representative of a broadcast network with back channel communication, an Internet Protocol (IP) network, and so on.

The client 104(n) may be configured in a variety of ways. For example, the client 104(n) may be configured as a computer that is capable of communicating over the network connection 114, such as a desktop computer, a mobile station, an entertainment appliance, a set-top box communicatively coupled to a display device as illustrated, a wireless phone, and so forth. For purposes of the following discussion, the client 104(n) may also relate to a person and/or entity that operate the client. In other words, client 104(n) may describe a logical client that includes a user, software and/or a machine (e.g., a client device).

The content provider 108 includes one or more items of content 116(k), where “k” can be any integer from 1 to “K”. The content 116(k) may include a variety of data, such as television programming, video-on-demand (VOD) files, and so on. The content 116(k) is communicated over the network connection 110 to the network operator 102.

Content 116(k) communicated via the network connection 110 is received by the network operator 102 and may be stored as one or more items of content 118(b), where “b” can be any integer from “1” to “B”. The content 118(b) may be the same as or different from the content 116(k) received from the content provider 108. The content 118(b), for instance, may include additional data for broadcast to the client 104(n), such as electronic program guide (EPG) data.

The client 104(n), as previously stated, may be configured in a variety of ways to receive the content 118(b) over the network connection 114. The client 104(n) typically includes hardware and software to transport and decrypt content 118(b) received from the network operator 102 for rendering by the illustrated display device. Although a display device is shown, a variety of other output devices are also contemplated, such as speakers.

The client 104(n) may also include digital video recorder (DVR) functionality, thereby converting broadcast content into non-broadcast content. For instance, the client 104(n) may include a storage device 120(n) to record content 118(b) as content 122(c) (where “c” can be any integer from one to “C”) received via the network connection 114 for output to and rendering by the display device. The storage device 120(n) may be configured in a variety of ways, such as a hard disk drive, a removable computer-readable medium (e.g., a writable digital video disc), and so on. Thus, content 122(c) that is stored in the storage device 120(n) of the client 104(n) may be copies of the content 118(b) that was broadcast via a stream from the network operator 102. Additionally, content 122(c) may be obtained from a variety of other sources, such as from a computer-readable medium that is accessed by the client 104(n), and so on.

The client 104(n) includes a communication module 124(n) that is executable on the client 104(n) to control content playback on the client 104(n), such as through the use of one or more “command modes”. The command modes, for instance, may provide non-linear playback of the content 122(c), i.e., time shift the playback of the content 122(c) such as to pause, rewind, fast forward, engage in slow motion playback, and the like from the memory 120(n).

The network operator 102 is illustrated as including a manager module 126. The manager module 126 is representative of functionality to configure content 118(b) for output (e.g., streaming) over the network connection 114 to the client 104(n). The manager module 126, for instance, may configure content 116(k) received from the content provider 108 to be suitable for transmission over the network connection 114, such as to “packetize” the content for distribution over the Internet, configuration for a particular broadcast channel, map the content 116(k) to particular channels, and so on.

Thus, in the environment 100 of FIG. 1, the content provider 108 may communicate the content 116(k) over a network connection 110 to a multiplicity of network operators, an example of which is illustrated as network operator 102. The network operator 102 may then broadcast the content 118(b) over a network connection to a multitude of clients, an example of which is illustrated as client 104(n). The client 104(n) may then store the content 118(b) in the storage device 120(n) as content 122(c), such as when the client 104(n) is configured to include digital video recorder (DVR) functionality.

The content 118(b) may also be representative of non-broadcast (e.g., time-shifted) content, such as video-on-demand (VOD) content that is streamed to the client 104(n) when requested, such as movies, sporting events, and so on. For example, the network operator 102 may execute the manager module 126 to provide a VOD system such that the content provider 108 supplies content 116(k) in the form of complete content files to the network operator 102. The network operator 102 may then store the content 116(k) as content 118(b). The client 104(n) may then request playback of desired content 118(b) by contacting the network operator 102 (e.g., a VOD server) and requesting a stream (e.g., feed) of the desired content. Thus, although the client 104(n) receives a stream, it is not a traditional broadcast.

In another example, the content 118(b) may further be representative of content (e.g., content 116(k)) that was recorded by the network operator 102 in response to a request from the client 104(n), in what may be referred to as a network DVR example. Like VOD, the recorded content 118(b) may then be streamed to the client 104(n) when requested. Interaction with the content 118(b) by the client 104(n) may be similar to interaction that may be performed when the content 122(c) is stored locally in the storage device 120(n), such as to employ one or more of the command modes.

To collect revenue using a traditional advertising model, the content provider 108 may embed advertisements in the content 116(k). Likewise, the network operator 102 may also embed advertisements 128(a) obtained from the advertiser 106 in the content 118(b) to also collect revenue using the traditional advertising model. For example, the content provider 108 may correspond to a “national” television broadcaster and therefore offer the content 116(k) and national advertising opportunities to advertisers, which are then embedded in the content 116(k). The network operator 102, on the other hand, may correspond to a “local” television broadcaster and offer the content 118(b) with the advertisements embedded by the content provider 108 as well as advertisements obtained from local advertisers to the client 104(n). Thus, the advertisements 130(d) which are included with the content 122(c) streamed to the client 104(n) may be provided from a variety of sources. Although national and local examples were described, a wide variety of other examples are also contemplated.

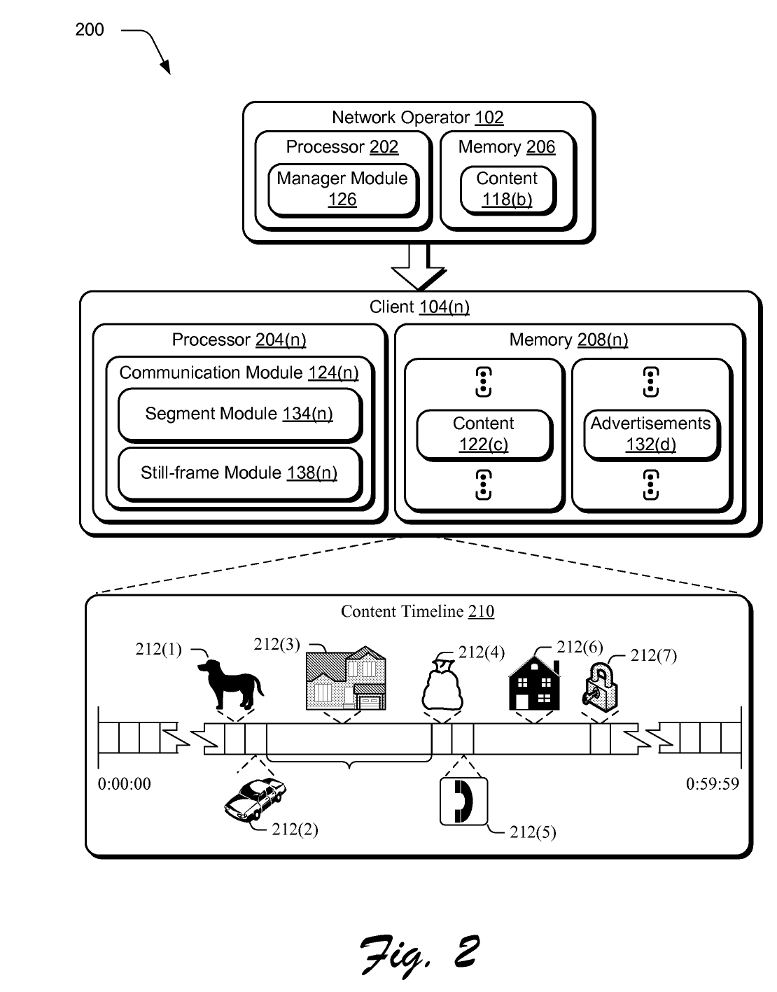

The manager module 126 is illustrated as including a segment module 132 which is representative of functionality to segment content (e.g., content 118(b)), such as into program segments (e.g., segments that do not contain advertisements) and advertising segments that contain advertisements. The segments, therefore, are distinct time segments of the content 118(b) which may be differentiated by “what” is contained in the segments, in this example program or advertising. Segmenting the content is not limited to the network operator 102 and may be performed by a variety of different entities, such as by a segment module 134(n) by the client 104(n) as illustrated in FIG. 1, exemplary operation of which will be further described in relation to FIG. 2.

The segment module 132 may also be representative of functionality to uniquely identify the segments. For example, the segment module 132 may derive a signature for each of the segments based on characteristics in the segment, such as volume, images within the segments, use of color, identification of logos, frequency of frame output, volume level, associated metadata, and so on. Thus, in this example the signature helps identify “what” is contained in the respective segment as opposed to a generic identifier (e.g., a number) that merely serves to name the segment but does not identify “what” is in the segment. These signatures may be utilized in a variety of ways, such as to identify matching advertisements (e.g., the same advertisements being output at different times) as well as similar advertisements, such as advertisements in a similar genre, having a similar output type (e.g., action vs. spokesperson), and so on. It should be noted that implementation of the functionality represented by the segment module 132 is not limited to the network operator 102 and may be performed by a variety of entities, such as the client 104(n) as illustrated by segment module 134(n), a third-party web service, and so on.

The network operator 102 is also illustrated as including a still-frame module 136 that is representative of functionality involving still-frame navigation. For instance, the still-frame module 136 may be configured as an executable module that finds still frames for segments of content based on signatures derived for the segments by the segment module 132. The still frames may then be used to provide navigation to corresponding segments. Although a single still frame module 136 is illustrated, a variety of still frame modules may be employed that are optimized to specific types of content. For example, a still frame module may be optimized for advertisements, news stories, music videos, “trailers”, and so on. Each of these modules, therefore, may be optimized to “look” for specific characteristics when selecting a still frame, such as corporate logos for advertisements, the news module may locate frames that are not composed primarily of a human head (e.g., to avoid having multiple “talking head” frames that are not easily differentiated), the music video module may look for images of a head and an instrument, a trailer segment may locate text that has an increased likelihood of being a title, and so on. Additionally, although this discussion described the use of a plurality of modules that are targeted towards particular types of content, the functionality represented by these targeted modules may be incorporated within a single module without departing from the spirit and scope thereof.

Like the segment module 132, functionality of the still-frame module 136 is also not limited to implementation by the network operator 102 and may be performed by a variety of devices, an example of which is illustrated as the still-frame module 138(n) of the client 104(n), further discussion of which may be found in relation to FIG. 2.

FIG. 2 depicts a system 200 in an exemplary implementation showing the network operator 102 of FIG. 1 and the client 104(n) in greater detail. The network operator 102 and the client 104(n) are both illustrated as devices (e.g., the client 104(n) is illustrated as a client device) having respective processors 202, 204(n) and memory 206, 208(n). Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Additionally, although a single memory 206, 208(n) is shown, respectively, for the network operator 102 and the client 104(n), a wide variety of types and combinations of memory may be employed, such as random access memory (RAM), hard disk memory, removable medium memory, and other types of computer-readable media.

The network operator 102 is illustrated as executing the manager module 126 on the processor 202, which is storable in memory 206. The manager module 126 in the example of FIG. 2 is executed to stream content 118(b) over a broadcast network illustrated as an arrow to the client 104(n).

The client 104(n) is illustrated as executing the communication module 124(n) having the segment module 134(n) and the still-frame module 138(n) on the processor 204(n), which is storable in memory 208(n). The communication module 124(n) is configured to receive content 118(b) via a broadcast from the network operator 102. The content 118(b) may be output immediately as it is received and/or stored in memory 208(n) as content 122(c) having advertisements 132(d).

The segment module 134(n) as previously described is representative of functionality to segment the content 118(b). The segment module 134(n), for instance, may derive a content timeline 210 as content 118(b) is received from the network operator 102 via a broadcast. The content timeline 210 is depicted as a plurality of blocks that are representative of segments of the content 118(b), each corresponding to a distinct time period in relation to an output of the content 118(b).

The segment module 134(n) is also representative of functionality to derive signatures of the content 118(b). For example, the segment module 134(n) may utilize a variety of characteristics that may help to uniquely identify the respective segments. Each of these characteristics may then be assigned to a dimension such that a multi-dimensional vector is derived that may act as a signature for the segment. Thus, the signature may directly identify the characteristics of a respective advertisement and/or program segment as well as to compare segments and the characteristics of the segments, one to another.

The signature may then be utilized to identify a particular still frame in the segment that is representative of the segment. For example, the signature may be thought of as identifying “what” is contained in the segment. Similar techniques (e.g., through the use of a multidimensional vector) may also be applied to still frames within the segment. The still frame (and more particularly the signature of the still frame) that most closely resembles the signature of the segment may thus be thought of as the still frame that most closely represents “what” is contained in the segment. A variety of additional considerations may also be employed to select the still frames, such as to ensure “distinctness” of the still frames through application of a distinctiveness algorithm, e.g., to ensure that still frames from different segments do not match to distinctly identify the segments, one from another.

Examples of still images 212(1)-212(7) are illustrated as associated with respective segments in the content timeline 210 through the use of phantom lines. These still images 212(1)-212(7) may be used for a variety of purposes, such as to be output in a user interface to provide content navigation, an example of which is shown in the following figure.

FIG. 3 is an illustration 300 of a display device 302 of the client 104(n) as outputting still images 212(1)-212(5) to provide navigation of content that was broadcast to the client 104(n). Each of the still images 212(1)-212(5) is illustrated as a bar displayed in conjunction with a concurrent output 304 of content 118(b) that is received via a broadcast and output in real time.

In the illustrated implementation, the still images 212(1)-212(5) have a displayed size that is proportional to an amount of time a respective segment is to be output. Accordingly, in the illustrated example still image 212(3) has a larger displayed size than still image 212(2) because the represented segment is to be output for a corresponding greater amount of time. A variety of other examples are also contemplated.

Selection of the still images 212(1)-212(5) (e.g., by a remote control, touch screen, cursor-control device, and so on) causes navigation to a respective segment. For example, selection of the still image 212(1) of the dog may cause navigation to a beginning of a segment that includes the still image 212(1), to the still image 212(1) itself, and so on. Further discussion of content navigation utilizing still images may be found in relation to the following exemplary procedures.

Generally, any of the functions described herein can be implemented using software, firmware, hardware (e.g., fixed-logic circuitry), manual processing, or a combination of these implementations. The terms “module”, “functionality” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer-readable memory devices. The features of the described techniques are platform-independent, meaning that the techniques may be implemented on a variety of commercial computing platforms having a variety of processors.

Exemplary Procedures

The following discussion describes still-image content navigation techniques that may be implemented utilizing the previously described environment, systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1, the system 200 of FIG. 2 and the illustration 300 of the user interface in FIG. 3.

FIG. 4 depicts a procedure 400 in an exemplary implementation in which content, which is received during a real-time broadcast, incorporates still-frame navigation techniques. Content is received via a real-time broadcast (block 402). The content, for instance, may be received by a network operator from a content provider. The content provider may correspond to a “national” broadcaster (e.g., CBS, ABC, NBC) that originated the content and includes advertisements in the content to collect revenue. This content may then be broadcast to a plurality of clients 104(n), such as to a plurality of different households having one or more set-top boxes.

A plurality of segments are formed from the content such that each of the segments defines a distinct time period (block 404), e.g., such that the segments do not “overlap”. For example, characteristics may be used to differentiate program segments from advertising segments. For instance, a higher volume level is generally observed for advertising segments as opposed to program segments. Scene changes, musical selection, dialog characteristics, identification of static images, and so on are further examples of characteristics that may be used to differentiate between programs and advertisements, as well as to differentiate between different advertisements, one from another, as well as program segments, one from another. As previously described, for instance, the signature may be computed as a multi-dimensional vector that describes characteristics of the segment.

A still frame is identified in each of the segments that is representative of the respective segment (block 406). The identified still frame, for instance, may be chosen based on inclusion of characteristics that are the closest (when compared with other still frames of the segment) to the segment as a whole. A signature, for example, may be computed for each still frame of the segment. The signature of the still frame that most closely resembles the signature of the segment may be chosen as the still frame that identifies the segment. A variety of other techniques is also contemplated, such as manual selection of the still frame, use of characteristics and hashing techniques, and so forth.

A plurality of the still frames are output in a user interface in which each of the still frames is selectable to navigate to a respective segment that includes the still frame (block 408). Further, the user interface having the plurality of the still frames may be output concurrently with at least a portion of the content (block 410). For example, as shown in relation to FIG. 3, a user interface may include still frames 212(1)-212(5) arranged as a bar, each being selectable to navigate to a respective segment of content from which it was derived. The user interface may also include a concurrent output 304 of content 118(b) broadcast from a head end of the network operator 102 to the client 104(n). A variety of other examples are also contemplated, such as the use of overlays, pop-up menus, and so on to display the still images.

FIG. 5 depicts a procedure 500 in an exemplary implementation in which an option is provided to fast forward content that was originally received via a broadcast stream. Content is received via a broadcast stream (block 502), such as from an “over-the-air” broadcast, “cable television” connection, satellite connection, and so forth.

A signature is computed for the content that identifies the content based on characteristics of the content (block 504). The signature, for instance, may be computed as a multidimensional vector as previously described or utilize other characteristics that have a direct correlation to “what” is contained within the content itself as opposed to an uncorrelated identifier, e.g., a numerical index, a randomly-generated alphanumerical identifier, a time stamp, and so forth.

An option is provided that is selectable to enable the content to be fast forwarded (block 506). For example, a user may press a button on a remote control that is communicatively coupled to a set-top box, use a cursor control device to interact with a broadcast-enabled computer, and so.

Upon selection of the option, another stream is located using the signature, the other stream having a portion of the content that is available for output that is not currently available for output via the broadcast stream (block 508). The signature, for instance, may be compared with a database of other signatures to locate desired content, such a database may be maintained locally at a client 104(n), at a head end of the network operator 102, via a third-party service at a website, and so on.

The other stream is then output (block 510). For example, the other stream may be provided from a video-on-demand (VOD) store that is maintained by the network operator 102. This video-on-demand store may support time-shifting functionality and command modes such that a user may fast forward to a desired scene. Thus, by switching to this other stream the user may be allowed to fast forward. In an implementation, this option may be provided for a fee that is payable by the client 104(n) to the network operator 102. A variety of other examples are also contemplated.

An option may also be provided that is selectable to locate related information using the signature (block 512). A user, for instance, may be provided with a menu that locates additional information that pertains to the content identified through use of the signature, such as biographies of actors and directors, navigation to a website to purchase related merchandise, and so forth. A variety of other examples are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
receiving content via a real-time broadcast;
identifying a still frame for each of a plurality of segments of the content that is representative of a respective said segment; and
outputting a plurality of said still frames in a user interface in which each said still frame is selectable to navigate to a respective said segment that includes the still frame.

2. A method as described in claim 1, wherein the identifying includes:
computing a signature of the respective said segment that identifies the content of the respective said segment based on characteristics of the content of the respective said segment; and
finding the still frame of the respective said segment that more closely corresponds to the signature than one or more other still frames of the respective said segment.

3. A method as described in claim 1, wherein the navigation to the respective said segment that includes the still frame is performed through local storage of the content at a client that performs the receiving, the identifying and the outputting.

4. A method as described in claim 1, wherein the outputting of the user interface and the still frames that are selectable includes a concurrent output of the content received via the real-time broadcast.

5. A method as described in claim 1, wherein the content is a television program received from a head end of a network operator.

6. A method as described in claim 1, wherein the outputting of the plurality of said still frames in the user interface is performed with the content such that the outputting includes text descriptions or picture-in-picture style video images.

7. A method as described in claim 1, wherein:
one or more said segments are program segments; and
at least one said segment is an advertising segment.

8. A method as described in claim 7, wherein:
the content includes a plurality of advertisements; and
each said advertisement is included in a respective said advertising segment separately, one from another.

9. A method as described in claim 7, wherein:
the content includes a plurality of advertisements arranged into a plurality of advertising blocks; and
each said advertising block is included in a respective said advertising segment separately, one from another.

10. A method as described in claim 1, wherein:
the content includes a plurality of advertisements;
at least one said advertisement is embedded by a content provider; and
one or more said advertisements are embedded by a network operator that broadcasts the content in the real-time broadcast.

11. One or more computer-readable media comprising instructions that are executable to:
find a first still frame to identify content in a first segment of content based on characteristics of the first segment of content;
find a second still frame to identify content in a second segment of the content based on characteristics of the second segment of the content in which the second still frame is taken at a different point in time in relation to the second segment than a point in time from which the first still frame was taken in relation to the first segment; and
output a user interface having the first still frame and the second still frame that are selectable to navigate to the first segment of the content and the second segment of the content, respectively.

12. One or more computer-readable media as described in claim 11, wherein:
a size of the first still frame in the user interface is based at least in part on an amount of time to output the first segment; and
a size of the second still frame in the user interface is based at least in part on an amount of time to output the second segment.

13. One or more computer-readable media as described in claim 11, wherein the characteristics used to find the first still frame is found in the first segment are different than the characteristics used to find the second still frame in the second segment of content.

14. One or more computer-readable media as described in claim 11, wherein the computer-executable instructions further cause the output of the user interface having the first still frame and the second still frame to include a concurrent output of the content received via a broadcast.

15. One or more computer-readable media as described in claim 11, wherein the computer-executable instructions find the second still frame using a signature generated from the second segment that is configured as a multidimensional vector, each said dimension corresponding to a respective said characteristic.

16. One or more computer-readable media as described in claim 11, wherein the computer-executable instructions further apply a distinctiveness algorithm to increase a likelihood that the second still frame is different than the first still frame.

17. A client comprising one or more modules to:
compute a signature for content received via a broadcast stream that identifies the content based on characteristics of the content; and
provide an option that is selectable to enable the content to be fast forwarded (506) by locating another stream using the signature, the other stream having a portion of the content that is available for output that is not currently available for output via the broadcast stream.

18. A client as described in claim 17, wherein:
the signature is a multidimensional vector; and
each of the dimensions of the vector correspond to a respective said characteristic that is usable to describe respective said content.

19. A client as described in claim 17, wherein the portion of the content is to be available via the broadcast stream at a future point in time.

20. A client as described in claim 17, wherein the content is not available to be fast forwarded to the portion via the broadcast stream.
